(19) United States
(12) Patent Application Publication
(10) Pub. No.: US 2019/0069092 A1
(43) Pub. Date: Feb. 28, 2019

(54) SPEAKER DIAPHRAGM

(71) Applicant: INNOVATION SOUND TECHNOLOGY CO., LTD., Shenzhen, Guangdong (CN)

(72) Inventors: Shun Ming YUEN, Shenzhen, Guangdong (CN); Lei ZHENG, Shenzhen, Guangdong (CN); Chun LAN, Shenzhen, Guangdong (CN)

(21) Appl. No.: 16/079,350

(22) PCT Filed: Feb. 23, 2016
(86) PCT No.: PCT/CN2016/074347

§ 371 Date: Aug. 23, 2018

(51) Int. Cl. H04R 7/12

(52) U.S. Cl. CPC H04R 7/125; H04R 2307/025

(57) ABSTRACT

The invention relates to a speaker diaphragm. The speaker diaphragm is composed of a dome portion located in the center and a circle of outer arc portion connected to the circumferential outer side of the dome portion. An outer diameter of the diaphragm is 38.9 mm to 39.95 mm. The dome portion has a dome height of 3.0 mm to 3.4 mm. The outer arc portion has an arc top height of 1.6 mm to 1.8 mm. An effective height between the dome portion and the outer arc portion is 0.8 mm to 1.0 mm. According to the speaker diaphragm of the invention, by increasing the effective height of the diaphragm and the dome height and by changing an outer arc shape and a pattern shape, the overall strength of the diaphragm is improved, the frequency peaks and valleys in a frequency response curve are reduced, and the high frequency is raised. In addition, a layer of PU damping material is also compounded between two different materials (PAR layer+PEEK layer) to increase the damping of the diaphragm.

### FIELD OF THE INVENTION

The present invention relates to a diaphragm on a speaker.

### BACKGROUND OF THE INVENTION

A moving coil type earphone is the most ordinary and common earphone whose driving unit is basically a small-sized moving coil speaker. A voice coil in a permanent magnetic field drives a vibrating diaphragm (diaphragm) connected thereto to vibrate. The moving coil type earphones, most of which may be driven by an earphone output on a sound device, are relatively high in efficiency, and reliable and durable.

However, at present, most of 40 mm speaker curves are discounted at 3 to 4 KHz, and there are many high frequency peaks and valleys, resulting in insufficient diaphragm strength or underdamping.

### SUMMARY OF THE INVENTION

The technical problem to be solved by the invention is to provide a speaker diaphragm which can improve the divisional vibration at high frequencies and make a frequency response curve smoother.

The technical solution proposed by the invention to solve the technical problem described above is as follows:

a speaker diaphragm, being composed of a dome portion located in the center and a circle of outer arc portion connected to the circumferential outer side of the dome portion, wherein

an outer diameter of the diaphragm is 38.9 mm to 39.95 mm;

the dome portion has a dome height of 3.0 mm to 3.4 mm;

the outer arc portion has an arc top height of 1.6 mm to 1.8 mm;

an effective height between the dome portion and the outer arc portion is 0.8 mm to 1.0 mm.

Optionally, the surface of the outer arc portion is also provided with a circle of array of annular concave patterns taking the center of the dome portion as a circle center, the concave patterns being elongated; an included angle between a connection line of the root of any of the concave patterns and the center of the dome portion and an axial centerline of the concave pattern is 120 degrees to 130 degrees.

Optionally, the diaphragm is made of a PAR material layer, a PU material layer and a PEEK material layer, which are of the same shape and are compounded, and has a thickness of 32u to 34u.

Optionally, the diaphragm is made of a PET material.

Optionally, the diaphragm is made of a PEN material.

Optionally, the diaphragm is made of a PEI material.

Optionally, the diaphragm is made of a PEEK material.

The invention has the beneficial effects:

by increasing the effective height of the diaphragm and the dome height and by changing an outer arc shape and a pattern shape, the overall strength of the diaphragm is improved, the frequency peaks and valleys in a frequency response curve are reduced, and the high frequency is raised.

In addition, a layer of PU damping material is also compounded between two different materials (PAR layer+PEEK layer) to increase the damping of the diaphragm.

### BRIEF DESCRIPTION OF THE DRAWINGS

The invention is further described below in combination with the drawings.

FIG. 1 is a side sectional view of a diaphragm in Embodiment 1;

FIG. 2 is a comparison diagram of frequency response curves before and after the adjustment of an effective height of the diaphragm in Embodiment 1;

FIG. 3 is a schematic structural diagram of a diaphragm in Embodiment 3;

FIG. 4 is a comparison diagram of frequency response curves before and after the adjustment of inclination angles of a concave pattern in Embodiment 3; and

FIG. 5 is a schematic structural diagram of a layer of a composite diaphragm in Embodiment 4;

### DETAILED DESCRIPTION OF THE PREFERRED EMBODIMENTS

### Embodiment 1

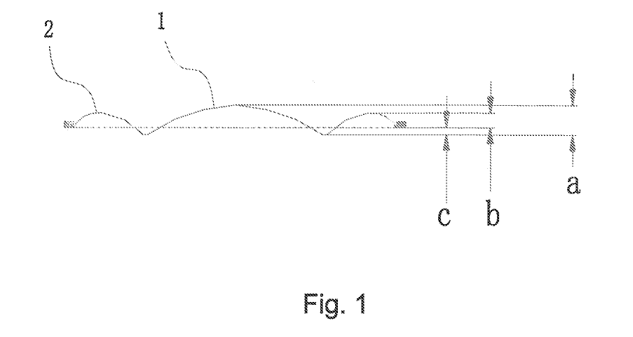

As shown in FIG. 1, a speaker diaphragm of the invention is composed of a dome portion 1 located in the center and a circle of outer arc portion 2 connected to the circumferential outer side of the dome portion.

An outer diameter of the diaphragm is 38.9 mm.

The dome portion 1 has a dome height a of 3.0 mm. The dome height a refers to a difference in height between the highest point in the middle of the dome portion 1 and the bottom edge of the dome portion 1.

The outer arc portion 2 has an arc top height b of 1.6 mm. The arc top height b refers to a difference in height between the highest point of the arc top of the outer arc portion 2 and the bottom edge of the outer side of the outer arc portion 2.

An effective height c between the dome portion 1 and the outer are portion 2 is 0.8 mm. The effective height c refers to a difference in height between the bottom edge of the outer side of the outer are portion 2 and the bottom edge of the dome portion 1.

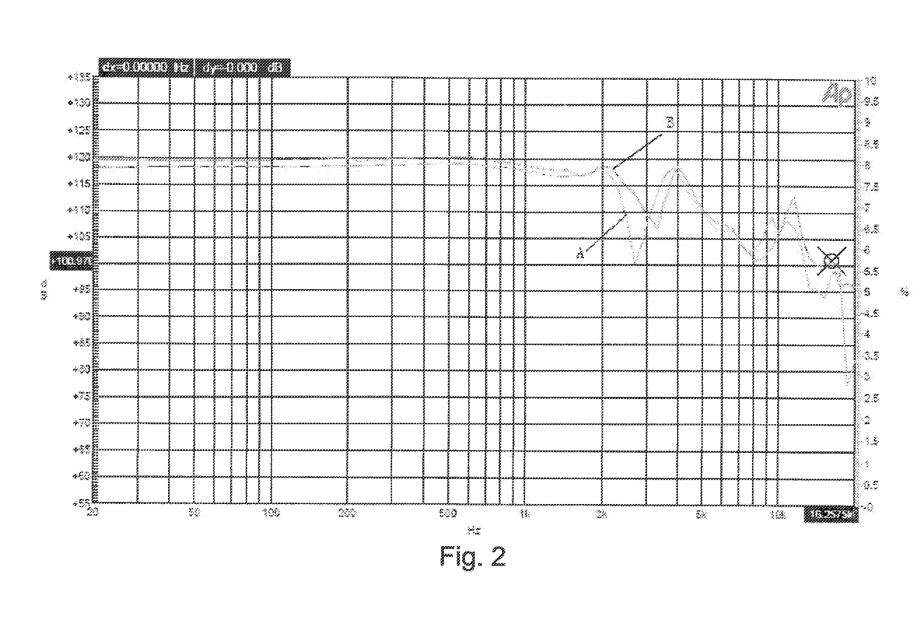

In the present embodiment, the diaphragm is subjected to a frequency response testing comparison before and after the effective height changes. The testing results as shown in FIG. 2. A curve A in FIG. 2 is a frequency response curve of the diaphragm having the effective height of 0.6 mm, and a curve B is a frequency response curve of the diaphragm having the effective height of 0.8 mm in the present embodiment. As can be seen from FIG. 2, after the outer arc is raised and the effective height is increased by 0.2 mm, peaks and valleys at 2 to 4 KHz are improved significantly.

### Embodiment 2

As shown in FIG. 1, a speaker diaphragm of the invention is composed of a dome portion 1 located in the center and a circle of outer are portion 2 connected to the circumferential outer side of the dome portion 1.

An outer diameter of the diaphragm is 39.95 mm.

The dome portion 1 has a dome height a of 3.4 mm.

The outer arc portion 2 has an arc top height b of 1.8 mm.

An effective height c between the dome portion 1 and the outer arc portion 2 is 1.0 mm.

### Embodiment 3

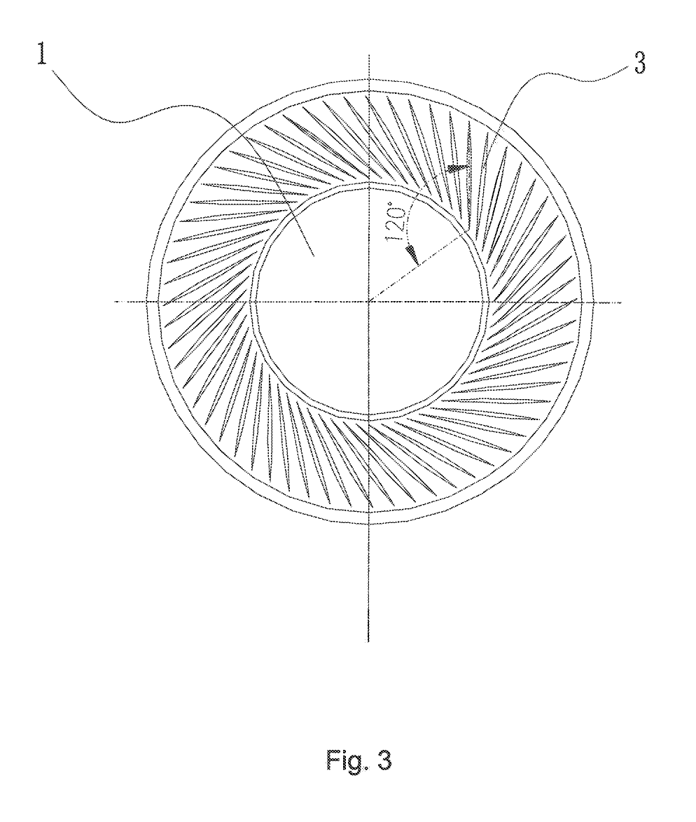

As shown in FIG. 3, in order to further improve the frequency response curve of the diaphragm, the present embodiment is improved on the basis of Embodiment 1 or Embodiment 2:

the surface of the outer arc portion 2 is also provided with a circle of array of annular concave pattern 3 taking the center of the dome portion 1 as a circle center, the concave patterns 3 being elongated.

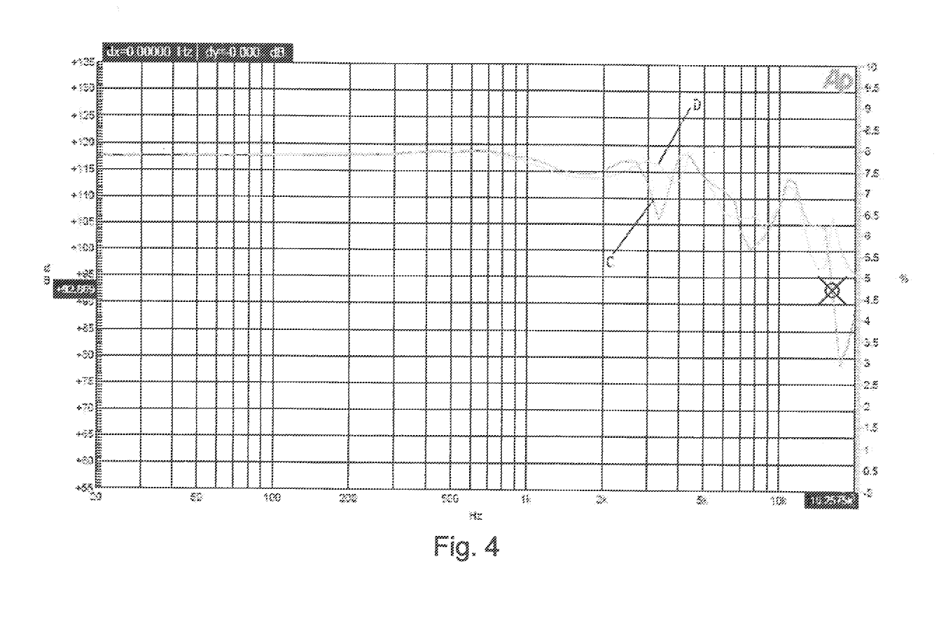

As shown in FIG. 4, an included angle between a connection line of the root of any of the concave patterns 3 and the center of the dome portion 1 and an axial centerline of the concave pattern 3 is 120 degrees.

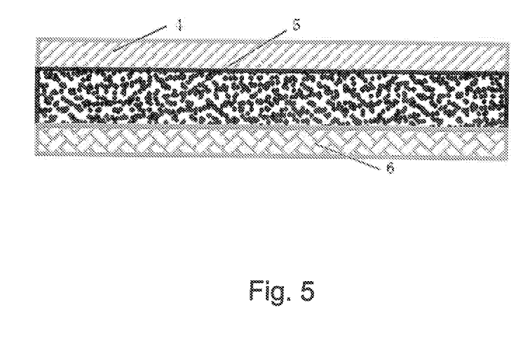

The diaphragm is subjected to a frequency response testing comparison before and after the inclination angles of the concave patterns 3 are adjusted. The testing results as shown in FIG. 5.

Optionally, an included angle between a connection line of the root of the concave pattern 3 and the center of the dome portion 1 and the axial centerline of the concave pattern 3 is 120 degrees to 130 degrees.

### Embodiment 4

Based on any of the above embodiments, as shown in FIG. 5, the diaphragm is made of a PAR material layer 4, a PU material layer 5 and a PEEK material layer 6, which are of the same shape and are compounded, and has a thickness of 32u to 34u.

Optionally, the diaphragm is made of a PET material.

Optionally, the diaphragm is made of a PEN material.

Optionally, the diaphragm is made of a PEI material.

Optionally, the diaphragm is made of a PEEK material.

The invention is not limited to the above embodiments, and the technical solutions of the embodiments of the invention can be combined with each other to form new technical solutions. In addition, the technical solutions formed by equivalent replacements all fall into the protection scope of the invention.

1. A speaker diaphragm, being composed of a dome portion located in the center and a circle of outer arc portion connected to the circumferential outer side of the dome portion, wherein
an outer diameter of the diaphragm is 38.9 mm to 39.95 mm;
the dome portion has a dome height of 3.0 mm to 3.4 mm;
the outer arc portion has an arc top height of 1.6 mm to 1.8 mm;
an effective height between the dome portion and the outer arc portion is 0.8 mm to 1.0 mm.

2. The speaker diaphragm according to claim 1, wherein the surface of the outer arc portion is also provided with a circle of array of annular concave patterns taking the center of the dome portion as a circle center, the concave patterns being elongated; an included angle between a connection line of the root of any of the concave patterns in the array of concave patterns and the center of the dome portion and an axial centerline of the concave pattern is 120 degrees to 130 degrees.

3. The speaker diaphragm according to claim 1, wherein the diaphragm is made of a PAR material layer, a PU material layer and a PEEK material layer, which are of the same shape and are compounded, and has a thickness of 32u to 34u.

4. The speaker diaphragm according to claim 1, wherein the diaphragm is made of a PET material.

5. The speaker diaphragm according to claim 1, wherein the diaphragm is made of a PEN material.

6. The speaker diaphragm according to claim 1, wherein the diaphragm is made of a PEI material.

7. The speaker diaphragm according to claim 1, wherein the diaphragm is made of a PEEK material.

8. The speaker diaphragm according to claim 2, wherein the diaphragm is made of a PAR material layer, a PU material layer and a PEEK material layer, which are of the same shape and are compounded, and has a thickness of 32u to 34u.

9. The speaker diaphragm according to claim 2, wherein the diaphragm is made of a PET material.

10. The speaker diaphragm according to claim 2, wherein the diaphragm is made of a PEN material.

11. The speaker diaphragm according to claim 2, wherein the diaphragm is made of a PEI material.

12. The speaker diaphragm according to claim 2, wherein the diaphragm is made of a PEEK material.
